(19) United States
(12) Patent Application Publication
(10) Pub. No.: US 2025/0016853 A1
(43) Pub. Date: Jan. 9, 2025

(54) COMMUNICATION DEVICE, COMMUNICATION DEVICE CONTROL METHOD, AND NON-TRANSITORY COMPUTER READABLE MEDIUM

(71) Applicant: CANON KABUSHIKI KAISHA, Tokyo (JP)

(72) Inventor: TAKAFUMI NAKAJIMA, Tokyo (JP)

(21) Appl. No.: 18/894,544

(22) Filed: Sep. 24, 2024

Related U.S. Application Data
(63) Continuation of application No. PCT/JP2023/010503, filed on Mar. 17, 2023.

(30) Foreign Application Priority Data
Mar. 31, 2022 (JP) 2022-059312

(51) Int. Cl. H04W 76/10; H04L 61/50; H04L 101/622; H04W 92/18

(52) U.S. Cl. CPC H04W 76/10; H04L 61/50; H04L 2101/622; H04W 92/18

(57) ABSTRACT

A communication device includes an establishment unit configured to establish a communication link at Layer 2 in wireless communication, and a transmission unit configured to transmit a message to a plurality of destinations via the communication link in a frame format including Layer-2 identifications (IDs) of the plurality of destinations.

### CROSS-REFERENCE TO RELATED APPLICATIONS

This application is a Continuation of International Patent Application No. PCT/JP2023/010503, filed Mar. 17, 2023, which claims the benefit of Japanese Patent Application No. 2022-059312, filed Mar. 31, 2022, both of which are hereby incorporated by reference herein in their entirety.

### TECHNICAL FIELD

The present disclosure relates to a control device, a communication device control method, and a non-transitory computer readable medium.

### BACKGROUND ART

In recent years, the 3rd Generation Partnership Project (3GPP®) Long Term Evolution (LTE) and Next Generation (NR) specifications have been developed. Among these, a standard specification called Sidelink communication is being developed. Sidelink communication realizes direct wireless communication, using an interface called PC5, between devices without using a mobile communication network (core network).

PTL 1 proposes a technology for direct wireless communication between vehicles using Sidelink communication. In the technology proposed in PTL 1, a vehicle shares its position, speed, and control information, for example, with surrounding vehicles to support the driver's recognition, judgment, and operation.

### CITATION LIST

### Patent Literature

PTL 1 Japanese Patent Laid-Open No. 2020-188405

However, in the technology of PTL 1, an identifier is used for each management area, and thus it is difficult to change partners, to which information is transmitted, in accordance with the content of information. In contrast, when the transmission destinations change for each transmission message in the conventional group-cast communication method in Sidelink communication, the change of identifier may be complicated, which may result in a lack of immediacy.

The problems to be solved by the present disclosure are to achieve multiple changeable destinations and low latency information exchange for multiple destination communication devices.

### SUMMARY OF INVENTION

A communication device according to an aspect of the present disclosure to solve the above-described problems includes an establishment unit configured to establish a communication link at Layer 2 in wireless communication compliant with the 3rd Generation Partnership Project (3GPP) standards, and a transmission unit configured to transmit a message to a plurality of destinations via the communication link in a frame format including Layer-2 identifications (IDs) of the plurality of destinations.

Moreover, a communication device according to another aspect of the present disclosure includes an establishment unit configured to establish a communication link at Layer 2 in wireless communication compliant with the 3rd Generation Partnership Project (3GPP) standards, and a reception unit configured to receive, via the communication link, a frame format including a plurality of Layer-2 IDs that include an Layer-2 ID of the communication device.

Further features of the present invention will become apparent from the following description of exemplary embodiments with reference to the attached drawings.

### BRIEF DESCRIPTION OF DRAWINGS

The attached drawings are included in the specification, form part of the specification, and are used to illustrate embodiments of the present disclosure and describe the principles of the present disclosure together with its description.

FIG. 1 is a diagram illustrating an example of the configuration of a formation driving communication system according to an embodiment of the present disclosure.

FIG. 2 is a block diagram illustrating an example of the functional configuration of a communication device according to the present embodiment.

FIG. 3 is a block diagram illustrating an example of the hardware configuration of the communication device.

FIG. 4 is a sequence diagram illustrating a communication sequence in a “broadcast communication method” and a “group-cast communication method”.

FIG. 5 is a sequence diagram illustrating a communication sequence in a “unicast communication method”.

FIG. 6 is a diagram illustrating a frame format for cases where messages are transmitted and received using a multi-ID communication method.

FIG. 7 is a sequence diagram illustrating an operation to establish a connection using L2IDs for Sidelink communication to perform broadcast communication.

FIG. 8 is a flowchart illustrating vehicle group formation processing performed by communication devices according to the present embodiment.

FIG. 9 is a flowchart illustrating broadcast message transmission processing performed by the communication devices.

FIG. 10 is a flowchart illustrating broadcast message reception processing performed by the communication devices.

FIG. 11 is a flowchart illustrating transmission destination selection processing based on message confidentiality.

FIG. 12 is a flowchart illustrating transmission destination selection processing based on message immediacy.

FIG. 13 is a flowchart illustrating transmission destination selection processing based on the number of transmission destinations.

### DESCRIPTION OF EMBODIMENTS

Other features and advantages of the present disclosure will become apparent from the following description with reference to the attached drawings. In the attached drawings, the same or similar configurations are denoted by the same reference numbers. The following is a detailed description of the embodiments of the present disclosure with reference to the attached drawings. Note that the following embodiments are not intended to limit the present disclosure, and not all of the combinations of features described in the embodiments are essential to the solutions of the present disclosure. The configurations of the embodiments may be modified or changed as appropriate depending on the specifications and various conditions (use conditions, use environments, for example) of the system and apparatus to which the present disclosure is applied. The technical scope of the present disclosure is defined by the claims and not by the following individual embodiments.

### System Configuration

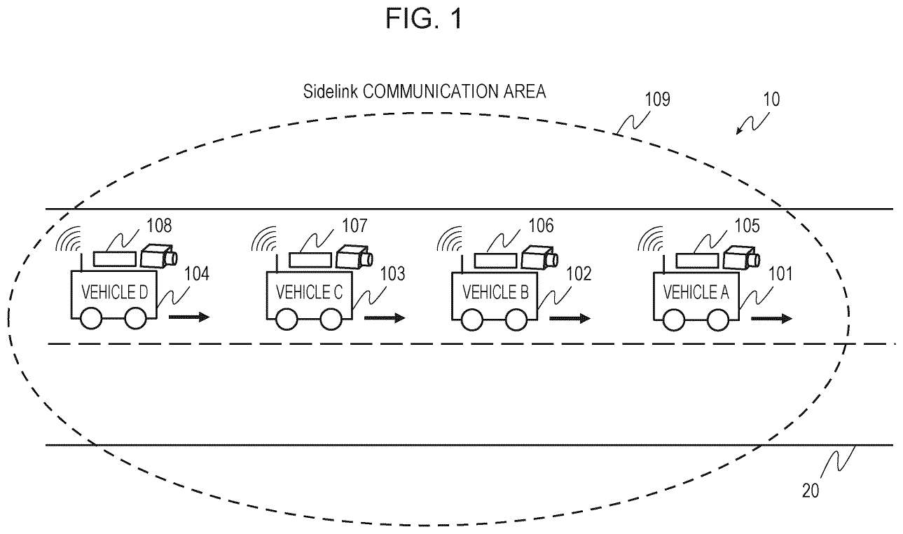

FIG. 1 is a diagram illustrating an example of the configuration of a formation driving communication system according to an embodiment of the present disclosure.

A formation driving communication system 10 is embedded in an automatic control system (not illustrated) for formation driving, and is responsible for the exchange of information necessary for formation driving. FIG. 1 illustrates an example of four vehicles 101 to 104 driving in formation under automatic operation control.

The formation driving communication system 10 includes multiple (four in the example illustrated in FIG. 1) communication devices 105 to 108 mounted in the multiple (four in the example illustrated in FIG. 1) vehicles 101 to 104, respectively. In the following description, in a case where the four vehicles 101 to 104 are distinguished from each other, the first vehicle 101 is referred to as “vehicle A” and the second vehicle 102 is referred to as “vehicle B”. The third vehicle 103 is referred to as “vehicle C”, and the fourth vehicle 104 is referred to as “vehicle D”.

Among the four vehicles 101 to 104, vehicle A is the lead vehicle, and vehicles B to D drive in a series to follow behind vehicle A. The vehicles 101 to 104 are an example of mobile units equipped with the in-vehicle communication devices 105 to 108 capable of performing wireless communication.

Each of the communication devices 105 to 108 captures a video of the traffic situation on a driving road 20, for example, using the mounted camera and analyzes, from the captured video, the road conditions and the situation of each vehicle driving in formation.

Each of the communication devices 105 to 108 can wirelessly report the analysis results and other information to the others, and the automatic control system for formation driving uses the reported information to realize formation driving. Each of the communication devices 105 to 108 can also report control information for formation driving to each other using wireless communication. Sidelink communication is used for wireless communication in the present embodiment.

In the present embodiment, a group-cast communication method and a communication method using a frame format including multiple Layer-2 IDs that identify destinations are selectively used as a message transmission communication method. In the following description, the above-described frame format including Layer-2 IDs of multiple destinations is referred to as a “multi-ID format” and the communication method in which the multi-ID format is used is referred to as a “multi-ID communication method”. Layer-2 IDs may be abbreviated as L2IDs.

A Layer-2 ID is a Layer-2 ID used in Sidelink communication and is an identifier that indicates the destination of communication in Sidelink communication specified by 3GPP. Sidelink communication is Sidelink communication (PC5) specified by 3GPP.

### Functional Configuration of Communication Device

Next, the functional configuration of the communication devices 105 to 108 will be described. Since each of the communication devices 105 to 108 has an identical functional configuration in the present embodiment, the functional configuration of the communication device 105 will be described as a representative in the following.

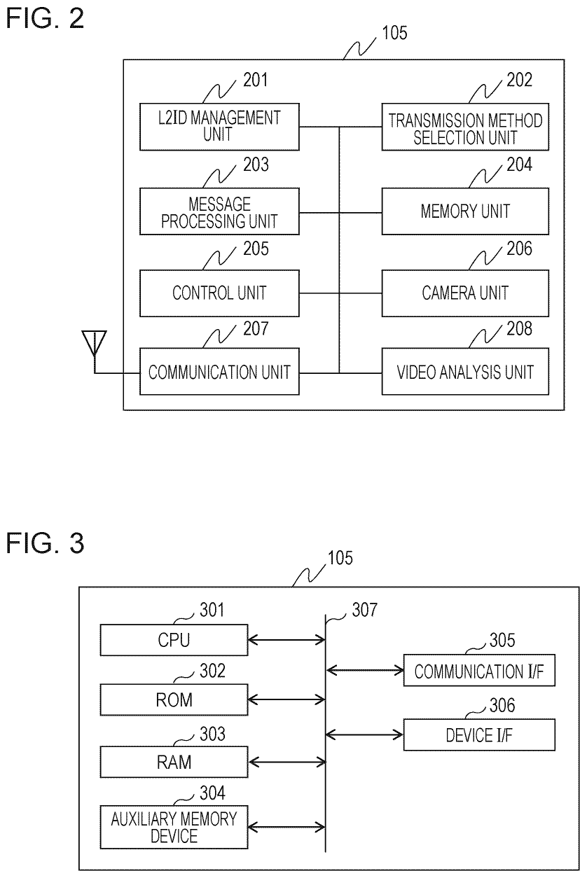

FIG. 2 is a block diagram illustrating an example of the functional configuration of the communication device 105 according to the present embodiment.

The communication device 105 includes an L2ID management unit 201, a transmission method selection unit 202, a message processing unit 203, a memory unit 204, a control unit 205, a camera unit 206, a communication unit 207, and a video analysis unit 208.

The L2ID management unit 201 generates an L2ID that identifies its own device (namely the communication device 105) and manages L2IDs that identify other devices (namely, one or more of the communication devices 106 to 108). In the present embodiment, the L2ID management unit 201 also determines L2IDs of transmission destinations used for broadcast transmission of messages from the L2IDs of other devices that the L2ID management unit 201 manages.

The transmission method selection unit 202 selects, in a case where broadcast transmission of messages is to be performed through Sidelink communication, the communication method from among the group-cast communication method and the multi-ID communication method. As the selection criteria in the transmission method selection unit 202, message confidentiality, message immediacy, and the number of transmission destinations may be used.

The message processing unit 203 generates messages for sharing road traffic information necessary for formation driving and messages for controlling formation driving. The message processing unit 203 forms, in a specified frame format, the generated messages into transmission messages for Sidelink communication that include L2IDs. The message processing unit 203 also includes the function of encrypting messages and the function of decrypting encrypted messages.

The memory unit 204 stores L2IDs and other information required for Sidelink communication.

The control unit 205 controls the entire communication device 105 and controls, for example, each of the functional units described above.

The camera unit 206 has general camera functions, such as image capture, to capture a video of traffic conditions on the driving road 20, for example.

The communication unit 207 performs wireless communication with other devices. For example, the communication unit 207 transmits a message generated by the message processing unit 203 to one of the communication devices 106 to 108. The communication unit 207 can transmit messages to all the communication devices 106 to 108. The communication unit 207 can also transmit messages to multiple communication devices selected from among the communication devices 106 to 108. The communication unit 207 also receives messages transmitted from other devices.

The communication unit 207 also transmits and receives L2IDs to and from other devices on the basis of commands from the L2ID management unit 201. That is, the L2ID management unit 201 reports the L2ID identifying its own device to other devices via the communication unit 207, and receives L2IDs reported from other devices via the communication unit 207. In other words, the L2ID management unit 201 shares the L2IDs with other devices via the communication unit 207.

The communication unit 207 transmits and receives security information necessary for message encryption and decryption to and from other devices. The communication unit 207 receives such security information from the message processing unit 203 and passes the security information to the message processing unit 203. That is, the message processing unit 203 shares security information with other devices via the communication unit 207.

The video analysis unit 208 analyzes the video captured by the camera unit 206 to analyze the situation on the road currently being driven on. Specifically, the video analysis unit 208 detects events that may affect the operation of vehicle A, such as the presence or absence of accidents, traffic jams, emergency vehicles, construction work vehicles, or vehicles traveling abnormally. The road traffic information described above is generated by the video analysis unit 208 on the basis of results detected by the video analysis unit 208.

The configuration illustrated in FIG. 2 is an example, and some (or all in some cases) of the functional blocks may be replaced with other functional blocks that realize similar functions, some functional blocks may be omitted, or further functional blocks may be added. One functional block illustrated in the following description may be divided into multiple functional blocks, or multiple functional blocks may be combined into a single functional block.

### Hardware Configuration of Communication Device

Next, the hardware configuration of the communication devices 105 to 108 will be described. Since each of the communication devices 105 to 108 has an identical hardware configuration in the present embodiment, the hardware configuration of the communication device 105 will be described as a representative in the following.

FIG. 3 is a block diagram illustrating an example of the hardware configuration of the communication device 105.

The communication device 105 includes a central processing unit (CPU) 301, a read-only memory (ROM) 302, a random access memory (RAN) 303, an auxiliary memory device 304, a communication interface (I/F) 305, a device interface (I/F) 306, and a bus 307. The bus 307 interconnects the individual constituent elements. CPU stands for central processing unit. ROM stands for read-only memory, and RAM stands for random access memory.

The CPU 301 controls the entire communication device 105 using computer programs and data stored in the ROM 302 or the RAM 303 to realize each functional unit of the communication device 105 illustrated in FIG. 2.

The ROM 302 stores programs and other items that do not require modification.

The RAM 303 temporarily stores programs and data supplied from the auxiliary memory device 304 and data supplied from outside via the communication I/F 305.

The auxiliary memory device 304 includes a hard disk drive, for example, and stores various data.

The communication I/F 305 is used to communicate with external devices. For example, the communication unit 207 illustrated in FIG. 2 wirelessly communicates with the communication devices 106 to 108, which are other in-vehicle communication devices and external devices, via the communication I/F 305.

The device I/F 306 connects various devices to the communication device 105, either as constituent elements of the communication device 105 or as external elements. For example, the device I/F 306 can connect, to the communication device 105, a display device for the user and others to check information managed by the communication device 105. The device I/F 306 can also connect, to the communication device 105, the camera unit 206 equipped with a mechanism to perform image capture.

FIG. 3 illustrates an example in which the constituent elements illustrated in FIG. 2 are implemented by programs and the CPU 301, but the constituent elements illustrated in FIG. 2 may be implemented by one or more dedicated hardware devices. When the constituent elements illustrated in FIG. 2 are implemented using hardware, for example, it is sufficient that dedicated circuits be automatically generated, by using a specified compiler, on a field-programmable gate array (FPGA) from a program for realizing each constituent element. FPGA stands for field-programmable gate array. A gate array circuit may be formed in substantially the same way as an FPGA and may be realized as a hardware device. The constituent elements illustrated in FIG. 2 may also be realized by an application specific integrated circuit (ASIC).

### Sidelink Communication and Layer-2 ID

In the following, communication methods in Sidelink communication will be described.

As communication methods in Sidelink communication, there are broadcast, group-cast, and unicast communication methods.

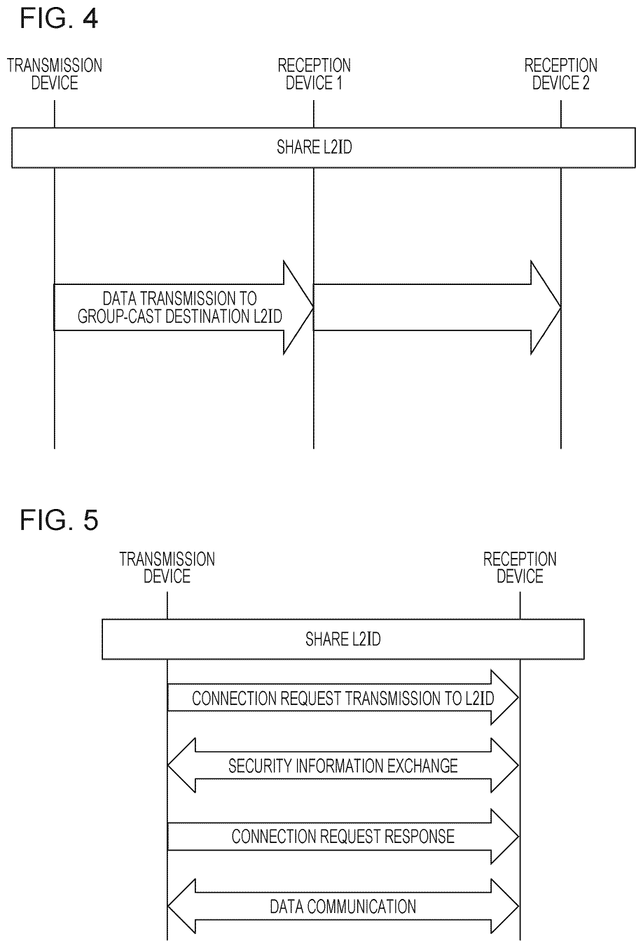

FIG. 4 is a sequence diagram illustrating a communication sequence in the “broadcast communication method” and “group-cast communication method”.

In the “broadcast communication method” and “group-cast communication method”, the devices on the transmission side and on the reception side (namely transmission and reception devices) share an L2ID that is an identifier during communication or have already shared the L2ID before communication. Moreover, the common L2ID is set in the transmission destination of the transmission device and the reception destination of the reception device.

The transmission device assigns, to a radio frame, the L2ID set as the transmission destination and transmits the radio frame. The radio frame is received by the reception device in which the L2ID common to the L2ID assigned to the radio frame is set as the reception destination.

That is, in the “broadcast communication method” and “group-cast communication method”, the setting of L2ID in the transmission and reception devices makes it possible to perform data communication between the devices. Thus, in a case where there are multiple reception devices in each of which the L2ID common to the L2ID assigned to the radio frame is set as the reception destination, the multiple reception devices will receive the radio frame simultaneously, thereby enabling broadcast communication.

In the present embodiment, messages used in the “broadcast communication method” and “group-cast communication method” are not encrypted.

Each L2ID in the present embodiment is an identifier stored in a 3-byte area within the frame format of Sidelink communication.

For L2IDs in the broadcast communication method, for example, each byte stored in all transmission and reception devices in advance has a fixed value at the time of shipment of the transmission and reception devices.

In contrast, L2IDs in the group-cast communication method are determined within groups at the time of group formation. That is, after the transmission and reception devices that form a group are identified, an L2ID that can identify the group among the target devices is determined, and the L2ID is shared among the communication devices.

FIG. 5 is a sequence diagram illustrating a communication sequence in the “unicast communication method”.

In the case of the “unicast communication method”, the transmission device transmits a connection request to the transmission destination identified by the shared L2ID. On the reception device side, security information is exchanged with the transmission device in a case where the L2ID common to the L2ID assigned to the connection request has been set as the reception destination. Once a secure communication link is established through the exchange of security information, it becomes possible to transmit and receive radio frames between the transmission and reception devices. Messages included in the radio frames transmitted and received in the “unicast communication method” are encrypted and decrypted using the exchanged security information.

Here, methods for sharing, for example, position, speed, and control information between vehicles through direct wireless communication performed between the vehicles using Sidelink communication will be considered.

In wireless communication using Sidelink communication, an L2ID is required to be shared between communication devices, as described above. That is, under automatic operation control using Sidelink communication, information exchange destinations are limited to the communication devices identified by the L2ID.

In a case where automatic operation control for formation driving is performed by the communication device installed in each vehicle using Sidelink communication, there is also a demand to send the same information to multiple information exchange destinations depending on the driving conditions between the lead vehicle and the following vehicles.

In the broadcast communication method, the L2ID for the broadcast communication method is shared in advance by all communication devices and is used. Thus, destination communication devices are not limited, and all the communication devices that exist within the communication range where target radio frames can be received are eligible to receive the target radio frames. Therefore, the broadcast communication method is not suitable for automatic operation control for formation driving, which requires information exchange limited to the desired information exchange destinations.

In the group-cast communication method, it is necessary to define and share an L2ID for a target group each time the target group changes, which may complicate the sharing process. For this reason, for communications that require immediacy, such as automatic operation control, it is desirable to perform broadcast communication using a simpler method. In addition, secure communication may be required in communication performed under automatic operation control, but there is no specified method for establishing secure communication in the group-cast communication system.

The unicast communication method is a communication method that establishes secure communication, but in order to exchange information under the automatic operation control for formation driving, for example, the same information is transmitted to each of multiple destination communication devices individually, which is inefficient for communication.

In addition to the “broadcast communication method”, “group-cast communication method”, and “unicast communication method”, communication using a multi-ID communication method using radio frames including multiple L2IDs that identify the destinations is possible in the present embodiment. The multi-ID communication method is a communication method that uses the transmission and reception of radio frames using Sidelink communication. The multi-ID communication method enables highly immediate communication that can be used for information exchange under the automatic operation control for formation driving, as described below.

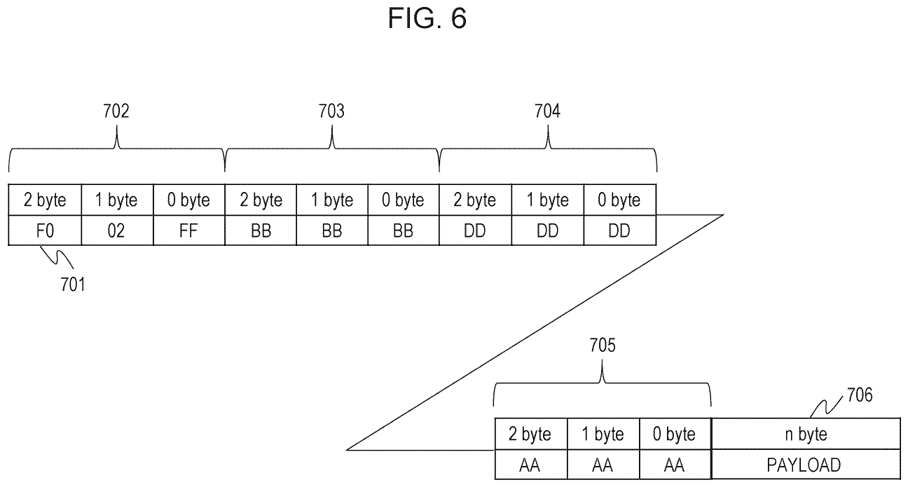

FIG. 6 is a diagram illustrating a frame format used when messages are transmitted and received using the multi-ID communication method.

A radio frame 701 is used to transmit and receive a broadcast message using Sidelink communication.

The radio frame 701 includes a leading destination identifier 702, and multiple (two in the example in FIG. 6) destination identifiers 703 and 704, a transmission source identifier 705, and a message payload 706, which follow behind the leading destination identifier 702.

The leading destination identifier 702 indicates that the radio frame 701 is a multi-ID format radio frame 701, for example, because the value of the most significant byte marked “2 byte” in FIG. 6 is “F0”. The method for indicating that the radio frame 701 is a multi-ID format radio frame 701 is not limited to the method described above. For example, it may be indicated that the radio frame 701 is a multi-ID format radio frame 701 by using the value of the most significant bit of the most significant byte in the leading destination identifier 702 set to “1”. Alternatively, a predetermined sequence of bytes or a bit at a predetermined location may be used to indicate that the radio frame 701 is a multi-ID format radio frame 701.

In the present embodiment, the value of the middle byte marked “1 byte” in the leading destination identifier 702 indicates how many destination identifiers are included after the leading destination identifier 702. Since the value of the middle byte is “02” in the example illustrated in FIG. 6, two destination identifiers 703 and 704 are included after the leading destination identifier 702. The number of destination identifiers included after the leading destination identifier 702 may be indicated at the location of another byte or by the number of bits of another byte in the leading destination identifier 702.

In the present embodiment, the value of the least significant byte marked “0 byte” is fixed to “FF”, but the least significant byte may be used for other purposes.

The multiple destination identifiers 703 and 704 following behind the leading destination identifier 702 are L2IDs that indicate the transmission destinations of the broadcast message. In the example illustrated in FIG. 6, the destination identifier 703 for a first destination is an L2ID having a value “BBBBBB” indicating vehicle B, and the destination identifier 704 for a second destination is an L2ID having a value “DDDDDD” indicating vehicle D.

The transmission source identifier 705 is an L2ID indicating the transmission source of the broadcast message. In the example illustrated in FIG. 6, the transmission source identifier 705 is an L2ID having a value “AAAAAA” indicating vehicle A.

The message payload 706, which follows behind the multiple destination identifiers 703 and 704, is the area where the road traffic and control information described above is stored.

As illustrated in FIG. 6, the multi-ID format indicates, in a byte area set at the beginning of the message for the Layer-2 IDs of multiple destinations, inclusion of Layer-2 IDs of the destinations and the number of Layer-2 IDs. The multi-ID format also includes Layer-2 IDs of multiple destinations as an extended area following behind the byte area.

### Transmission and Reception Processing

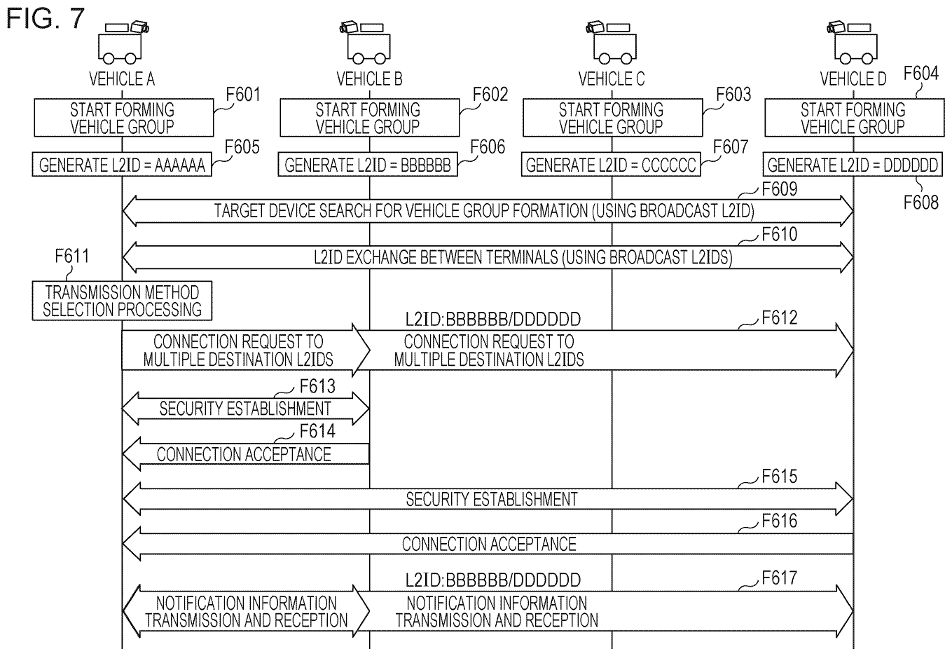

Referring to FIG. 7, message transmission and reception processing performed by the formation driving communication system 10 according to the present embodiment will be described.

FIG. 7 is a sequence diagram illustrating the operation of establishing a connection using L2IDs for Sidelink communication to perform broadcast communication.

First, in each of vehicles A to D, the formation of a vehicle group for formation driving is started (F601 to F604). Specifically, for example, software applications are launched on the communication devices 105 to 108 mounted in vehicles A to D, respectively.

Subsequently, in each of vehicles A to D, an L2ID identifying a corresponding one of the communication devices 105 to 108 mounted in the vehicle is generated (F605 to F608). In the present embodiment, L2IDs are automatically generated in the communication devices 105 to 108 of vehicles A to D, respectively. Note that a pre-defined and stored value may be used as the L2ID in each of vehicles A to D.

In the present embodiment, the value of the L2ID of vehicle A is, for example, “AAAAAA” and the value of the L2ID of vehicle B is, for example, “BBBBBB”. The value of the L2ID of vehicle C is, for example, “CCCCCC”, and the value of the L2ID of vehicle D is, for example, “DDDDDD”.

Subsequently, a search for target devices to form the vehicle group is performed. This search is performed using broadcast communication through Sidelink communication.

That is, a search message (F609) with a fixed L2ID, which is defined as an L2ID for broadcast communication, is transmitted and received between the communication devices 105 to 108. As this search message, for example, a radio frame is transmitted and received in which identification information including whether or not to be a formation target of the vehicle group is stored in the payload in a Sidelink communication format. In the present embodiment, for example, such identification information is also defined in advance and stored in the communication devices 105 to 108 of vehicles A to D that are group formation targets.

When the target devices for group formation (that is, the communication devices 105 to 108) are found by transmitting and receiving the search message, a message (F610) for L2ID exchange is created and transmitted and received between the communication devices 105 to 108.

As a message for L2ID exchange, a radio frame is transmitted and received in which the L2ID of its own device and the L2IDs of the target communication devices for the vehicle group are included in the message payload. By broadcasting the message for L2ID exchange using the L2ID for broadcast, the L2IDs of the communication devices that are vehicle group formation targets are shared between the vehicles. The vehicle group formation is completed when the L2IDs are shared.

In the present embodiment, when a message for L2ID exchange is transmitted and received, the multi-ID format is also transmitted and received as part of the message payload. That is, the communication devices 105 to 108 report messages including format information representing the multi-ID format to other devices using broadcast communication.

Note that, in the example illustrated in FIG. 7, the search message (F609) and the message for L2ID exchange (F610) are described as separate messages, but these messages may be transmitted and received as part of a single radio frame.

In a case where, after the vehicle group is formed, road traffic information or other information that should be transmitted via broadcast occurs in vehicle A, for example, the communication device 105 of vehicle A performs transmission method selection processing (F611). In the transmission method selection processing, either the group-cast communication method or the multi-ID communication method is selected. That is, the communication devices 105 to 108 transmit messages using the transmission method selected from the multi-ID communication method and the group-cast communication method. FIG. 7 illustrates a sequence in a case where the multi-ID communication method is selected.

In the present embodiment, the transmission destinations for broadcast transmission are determined in accordance with the content of the road traffic information and other information to be transmitted via broadcast each time the information is generated. FIG. 7 illustrates, for example, a sequence for a case where the communication device 106 of vehicle B and the communication device 108 of vehicle D are determined to be transmission destinations. In the example illustrated in FIG. 7, vehicle C is not a transmission destination, but vehicle C could also be a transmission destination in another broadcast transmission.

In a case where messages are transmitted via broadcast using the multi-ID communication method, a connection request including multiple L2IDs that identify the individual communication devices 106 and 108 of vehicles B and D that are transmission destinations is transmitted from the communication device 105 of vehicle A (F612). As a result of the connection request, the communication device 105 of vehicle A and the communication device 106 of vehicle B establish a secure link (F613). After the link is established, the communication device 106 of vehicle B transmits a connection acceptance to the communication device 105 of vehicle A (F614).

Similarly, the communication device 105 of vehicle A and the communication device 108 of vehicle D establish a secure link (F615). After the link is established, the communication device 108 of vehicle D transmits a connection acceptance to the communication device 105 of vehicle A (F616).

When the communication device 105 of vehicle A receives the connection acceptances from the communication device 106 of vehicle B and the communication device 108 of vehicle D, the communication device 105 of vehicle A transmits, via broadcast, a message in a multi-ID format to vehicle B and vehicle D using the multi-ID communication method, the message including road traffic information and other information to be reported (F617).

That is, the communication device 105 of vehicle A establishes a communication link at Layer 2 in wireless communication. Then, the communication device 105 of vehicle A transmits, via the above-described communication link, messages in a format including L2IDs of multiple destinations to the multiple destinations.

In addition, the communication device 106 of vehicle B and the communication device 108 of vehicle D establish a communication link at Layer 2 in wireless communication. The communication device 106 of vehicle B and the communication device 108 of vehicle D receive, via the above-described communication link, messages transmitted in the format including the multiple L2IDs including the L2IDs of vehicles B and D.

Since the L2ID sharing required for the multi-ID communication method is completed by the time when the vehicle group is formed, the time from when road traffic information to be reported arises to when the communication is performed is short, and immediate communication is possible using Sidelink communication. In addition, even when the transmission destinations change, the sharing of a new L2ID is unnecessary in the multi-ID communication method. Furthermore, since a broadcast message can be transmitted to multiple transmission destinations using one radio frame in the multi-ID communication method, the processing complexity on the transmission side can be suppressed. Thus, for example, the drivers of the individual vehicles 101 to 104 can exchange vehicle and road traffic information with low latency.

In addition, even in the multi-ID communication method, messages are encrypted and communicated through the link through which security information has been exchanged, and thus highly confidential broadcast communication is possible.

The processing procedures performed by the communication devices 105 to 108, which realize the sequence described above, will be described with reference to flowcharts.

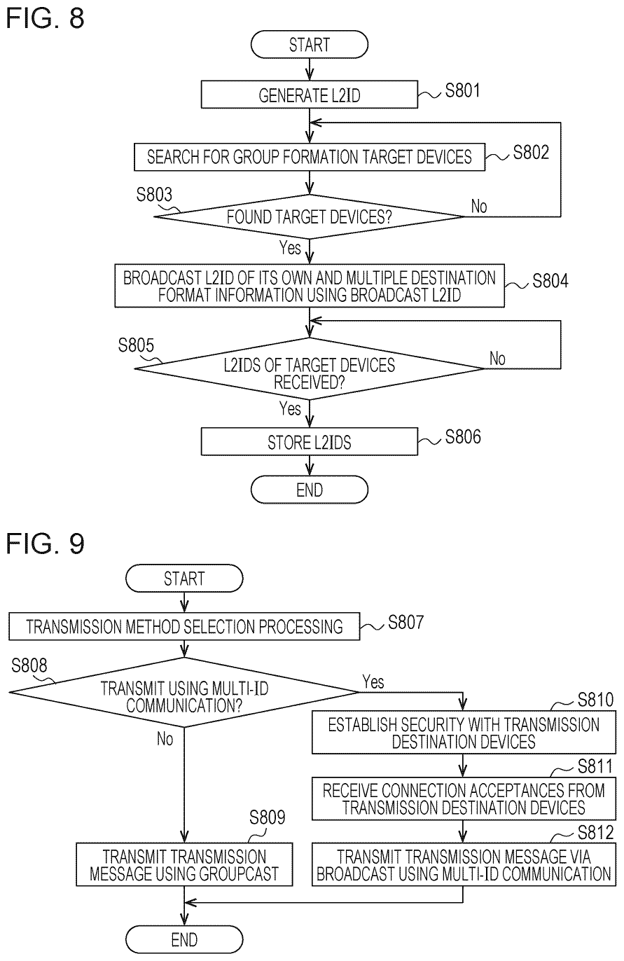

FIG. 8 is a flowchart illustrating vehicle group formation processing performed by the communication devices 105 to 108 according to the present embodiment.

When group formation is started, the communication devices 105 to 108 generate their own L2IDs using the L2ID management units 201 (S801).

Next, the communication devices 105 to 108 search for devices that are vehicle group formation targets using an L2ID for broadcast communication (S802).

When target devices are found (Yes in S803), the communication devices 105 to 108 broadcast their own L2IDs to the target devices using the L2ID for broadcast communication (S804). When broadcasting the L2IDs, the communication devices 105 to 108 also share the multi-ID formats with the target devices, the multi-ID formats being included in radio frames for broadcast. For example, even in a case where some of the communication devices 105 to 108 do not store a multi-ID format, this sharing enables multi-ID communication within the vehicle group.

Note that in a case where a target device is not found (No in S803), the process returns to S802, and the communication devices 105 to 108 continue their search for a target device.

After broadcasting the L2IDs in S804, the communication devices 105 to 108 wait to receive the L2IDs of the target devices transmitted from the target devices (S805).

In a case where the L2IDs of the target devices are received (Yes in S805), the communication devices 105 to 108 store the received L2IDs of the target devices in the memory units 204 (S806) and manage them using the L2ID management units 201.

FIG. 9 is a flowchart illustrating broadcast message transmission processing performed by the communication devices 105 to 108.

When a broadcast message including information to be transmitted to multiple destinations is generated by any of the message processing units 203, the corresponding one of the communication devices 105 to 108 performs transmission method selection processing (S807). The details of the transmission method selection processing will be described later. By performing the transmission method selection processing, either the group-cast communication method or the multi-ID communication method is selected as the broadcast message transmission method.

In a case where the multi-ID communication method is selected as a result of the transmission method selection processing performed in S807 (Yes in S808), the corresponding one of the communication devices 105 to 108 performs security establishment with the transmission destination devices (S810). After performing security establishment, the corresponding one of the communication devices 105 to 108 receives connection acceptances from the transmission destination devices (S811), and thereafter transmits a broadcast message using the multi-ID format (S812).

That is, the corresponding one of the communication devices 105 to 108 shares the security information necessary for message encryption with each of the multiple destinations indicated by the L2IDs included in the message, and encrypts, using the security information, the message to be transmitted in the multi-ID format.

In a case where the group-cast communication method is selected as a result of the transmission method selection processing performed in S807 (No in S808), the corresponding one of the communication devices 105 to 108 transmits a broadcast message using the group-cast communication method (S809).

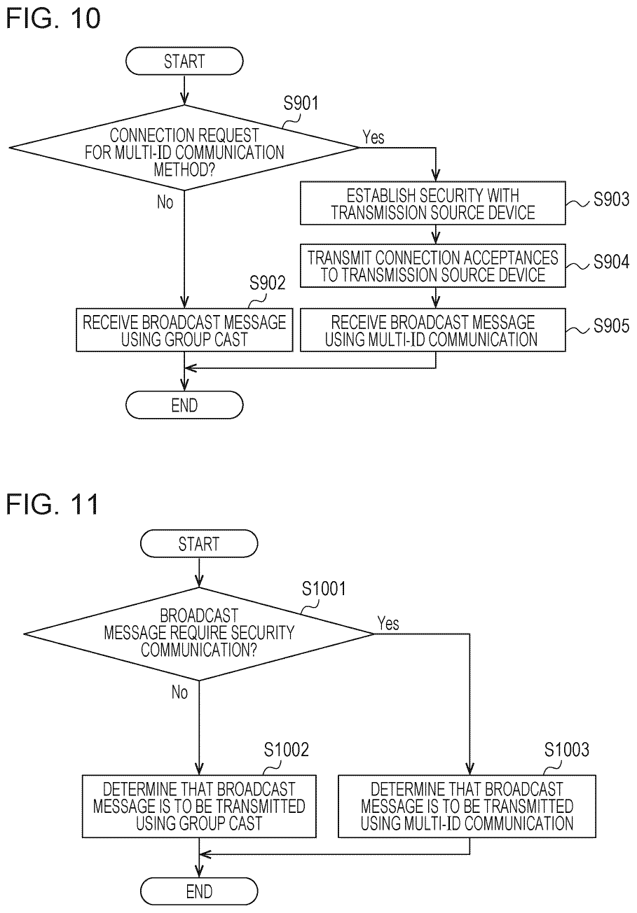

FIG. 10 is a flowchart illustrating broadcast message reception processing performed by the communication devices 105 to 108.

Upon receiving the broadcast message, the communication devices 105 to 108 check if there is a connection request for communication for the multi-ID communication method (S901).

In a case where there is not a connection request for the multi-ID communication method (No in S901), the communication devices 105 to 108 perform reception processing using the group-cast communication method (S902). In contrast, in a case where there is a connection request for the multi-ID communication method (Yes in S901), the communication devices 105 to 108 perform security establishment with the transmission source device (S903).

After performing security establishment, the communication devices 105 to 108 transmit connection acceptances to the transmission source device (S904), and thereafter receive a broadcast message (message payload) from the transmission source device using the multi-ID communication method (S905).

That is, the communication devices 105 to 108 share the security information necessary for message decryption with the transmission source of the message, and decrypt, using the security information, the encrypted message received in the multi-ID format.

The transmission destination selection processing will be described below.

The communication devices 105 to 108 select a broadcast transmission method using the transmission method selection units 202. As described above, for example, message confidentiality, message immediacy, and the number of transmission destinations may be used as criteria for selecting a transmission method.

FIG. 11 is a flowchart illustrating the transmission destination selection processing based on message confidentiality.

In the transmission destination selection processing represented by the flowchart of FIG. 11, it is determined whether or not a broadcast message requires security communication (S1001).

In a case where the broadcast message is a less confidential broadcast message that does not require security communication (No in S1001), it is determined that the broadcast message is to be transmitted using the group-cast communication method (S1002).

In a case where the broadcast message is a highly confidential broadcast message that requires security communication (Yes in S1001), it is determined that the broadcast message is to be transmitted using the multi-ID communication method (S1003).

That is, in the transmission destination selection processing represented by the flowchart of FIG. 11, in a case where the message is a message that requires confidentiality, transmission in the multi-ID format is selected as the transmission method. In a case where the message is a message that does not require confidentiality, transmission using the group-cast communication is selected as the transmission method.

The confidentiality of the message is the criterion for determination, and thus it becomes possible to perform broadcast transmission that matches the confidentiality of the broadcast message.

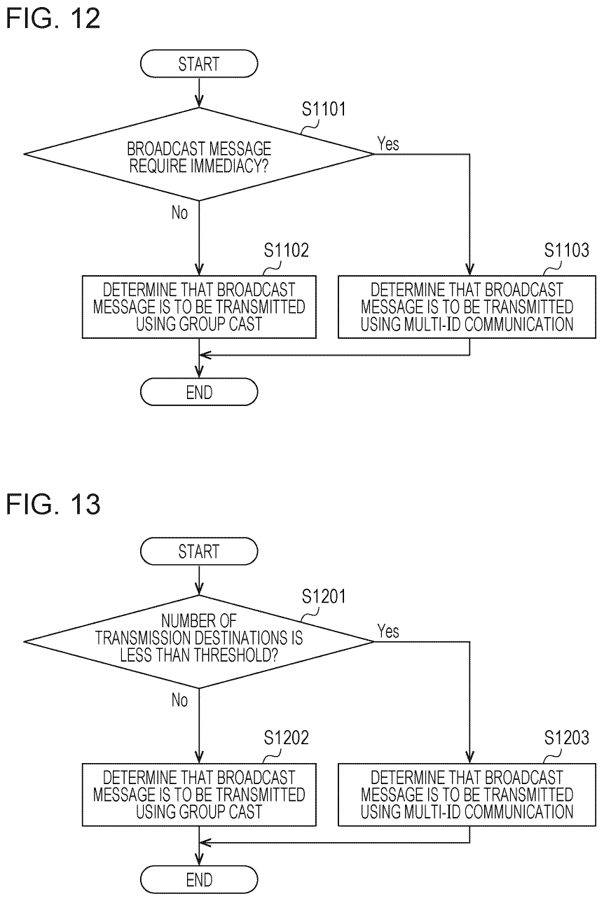

FIG. 12 is a flowchart illustrating the transmission destination selection processing based on message immediacy.

In the transmission destination selection processing represented by the flowchart of FIG. 12, it is determined whether or not a broadcast message requires immediacy (S1101).

In a case where the broadcast message is a broadcast message that does not require immediacy (No in S1101), it is determined that the broadcast message is to be transmitted using the group-cast communication method (S1102).

In a case where the broadcast message is a broadcast message that requires immediacy (Yes in S1101), it is determined that the broadcast message is to be transmitted using the multi-ID communication method (S1103).

That is, in the transmission destination selection processing represented by the flowchart of FIG. 12, in a case where the message requires immediacy, transmission in the multi-ID format is selected as the transmission method. In a case where the message does not require immediacy, transmission using the group-cast communication is selected as the transmission method.

The immediacy of the message is the criterion for determination, and thus it becomes possible to perform broadcast transmission that matches the immediacy of the broadcast message.

FIG. 13 is a flowchart illustrating the transmission destination selection processing based on the number of transmission destinations.

In the transmission destination selection processing represented by the flowchart of FIG. 13, it is determined whether or not the number of transmission destinations is less than a threshold (S1201).

In a case where the number of transmission destinations is greater than or equal to the threshold (No in S1201), it is determined that the broadcast message is to be transmitted using the group-cast communication method (S1202).

In a case where the number of transmission destinations is less than the threshold (Yes in S1201), it is determined that the broadcast message is to be transmitted using the multi-ID communication method (S1203).

That is, in the transmission destination selection processing represented by the flowchart of FIG. 13, in a case where the number of message destinations is less than a predetermined number, transmission in the multi-ID format is selected as the transmission method. In a case where the number of message destinations exceeds the predetermined number, transmission using the group-cast communication is selected as the transmission method.

The number of transmission destinations is the criterion for determination, and thus it becomes possible to perform broadcast transmission that matches the number of transmission destinations.

### OTHER EMBODIMENTS

The present disclosure can be implemented as embodiments such as a system, a device, a method, a program, or a recording medium (storage medium), for example. Specifically, the present disclosure may be applied to a system formed by multiple devices (for example, a host computer, an interface device, a web application, or the like) or to an apparatus formed by a single device.

Moreover, the present disclosure can also be realized by supplying a program (computer program) that realizes one or more functions of the embodiments described above to a system or apparatus via a network or recording medium (storage medium). One or more processors in the computer of that system or apparatus read out and execute the program. In this case, the program (program code) itself that is read out from the recording medium will realize the functions of the embodiments. A recording medium in which the program is recorded may also be included in the present disclosure.

In addition, not only are the functions of the embodiments realized by a computer reading out and executing the program, but an operating system (OS), for example, running on the computer may also perform part or all of the actual processing on the basis of the instructions of the program to realize the functions of the embodiments described above through that processing.

Furthermore, a program read out from a recording medium is written into the memory of a function expansion card inserted into a computer or into the memory of a function expansion unit connected to the computer, and thereafter the CPU, for example, included in the function expansion card or function expansion unit may perform part or all of the actual processing on the basis of the instructions of the program to realize the functions of the above-described embodiments through that processing.

In a case where the present disclosure is applied to the above-described recording medium, that recording medium will store a program corresponding to the flowcharts described earlier.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device comprising:
an establishment unit configured to establish a communication link at Layer 2 in wireless communication compliant with a 3rd Generation Partnership Project (3GPP) standards; and
a transmission unit configured to transmit a message to a plurality of destinations via the communication link in a frame format including Layer-2 identifications (IDs) of the plurality of destinations.

2. A communication device comprising:
an establishment unit configured to establish a communication link at Layer 2 in wireless communication compliant with a 3rd Generation Partnership Project (3GPP) standards; and
a reception unit configured to receive, via the communication link, a frame format including a plurality of Layer-2 IDs that include a Layer-2 ID of the communication device.

3. The communication device according to claim 1, wherein
the Layer-2 IDs are Layer-2 IDs used in Sidelink communication.

4. The communication device according to claim 1, wherein
the Sidelink communication is Sidelink communication (PC5) compliant with 3GPP standards, and
the Layer-2 IDs are identities indicating communication destinations in Sidelink communication compliant with 3GPP standards.

5. The communication device according to claim 1, wherein the frame format includes information indicating inclusion of the Layer-2 IDs of the plurality of destinations.

6. The communication device according to claim 5, wherein the frame format indicates, in a byte area set at beginning of a message for the Layer-2 IDs of the plurality of destinations, inclusion of the Layer-2 IDs of the plurality of destinations and the number of Layer-2 IDs, and includes the Layer-2 IDs of the plurality of destinations as an extended area following behind the byte area.

7. The communication device according to claim 1, further comprising:
an encryption unit configured to encrypt a message to be transmitted in the frame format; and
a sharing unit configured to share security information necessary for message encryption with each of the plurality of destinations indicated by the Layer-2 IDs included in the message.

8. The communication device according to claim 2, further comprising:
a decryption unit configured to decrypt an encrypted message received in the frame format; and
a sharing unit configured to share security information necessary for message decryption with a transmission source of the message.

9. The communication device according to claim 1, further comprising:
a reporting unit configured to report a message including frame format information representing the frame format to another device using broadcast communication.

10. The communication device according to claim 1, wherein the transmission unit is a unit configured to transmit the message using a method selected from transmission in the frame format and transmission using group-cast communication,
the communication device further comprising: a selection unit configured to select a transmission method to be performed by the transmission unit.

11. The communication device according to claim 10, wherein the selection unit selects transmission in the frame format as a transmission method to be performed by the transmission unit in a case where the message requires immediacy, and selects transmission using group-cast communication as a transmission method to be performed by the transmission unit in a case where the message does not require immediacy.

12. The communication device according to claim 10, wherein the selection unit selects transmission in the frame format as a transmission method to be performed by the transmission unit in a case where the message requires confidentiality, and selects transmission using group-cast communication as a transmission method to be performed by the transmission unit in a case where the message does not require confidentiality.

13. The communication device according to claim 10, wherein the selection unit selects transmission in the frame format as a transmission method to be performed by the transmission unit in a case where the number of message destinations is less than a predetermined number, and selects transmission using group-cast communication as a transmission method to be performed by the transmission unit in a case where the number of message destinations exceeds the predetermined number.

14. A communication system comprising:
a communication device including an establishment unit configured to establish a communication link at Layer 2 in wireless communication compliant with a 3rd Generation Partnership Project (3GPP) standards and a transmission unit configured to transmit a message to a plurality of destinations via the communication link in a frame format including Layer-2 identifications (IDs) of the plurality of destinations; and
the communication device according to claim 2.

15. A communication device control method comprising:
establishing a communication link at Layer 2 in wireless communication compliant with a 3rd Generation Partnership Project (3GPP) standards; and
transmitting a message to a plurality of destinations via the communication link in a frame format including Layer-2 identifications (IDs) of the plurality of destinations.

16. A communication device control method comprising:
establishing a communication link at Layer 2 in wireless communication compliant with a 3rd Generation Partnership Project (3GPP) standards; and
receiving, via the communication link, a frame format including a plurality of Layer-2 IDs that include an Layer-2 ID of the communication device.

17. A non-transitory computer readable medium storing a program causing a computer to function as:
an establishment unit configured to establish a communication link at Layer 2 in wireless communication compliant with a 3rd Generation Partnership Project (3GPP) standards; and
a transmission unit configured to transmit a message to a plurality of destinations via the communication link in a frame format including Layer-2 identifications (IDs) of the plurality of destinations.
